(19) United States
(12) Patent Application Publication
(10) Pub. No.: US 2018/0120171 A1
(43) Pub. Date: May 3, 2018

(54) METHOD AND DEVICE FOR APPLYING A FLEXIBLE SEAL TO THE PERIPHERY OF A COMPONENT

(71) Applicant: Ford Global Technologies, LLC, Dearborn, MI (US)

(72) Inventors: Philip Stefan Bauer, Coline (DE); Hans-Joachim Mayntz, Kreuzau (DE)

(73) Assignee: Ford Global Technologies, LLC, Dearborn, MI (US)

(21) Appl. No.: 15/789,389

(22) Filed: Oct. 20, 2017

(30) Foreign Application Priority Data
Oct. 28, 2016 (DE) 102016221271.0

(51) Int. Cl. G01L 1/04; B23P 19/04; G01B 3/12; G01B 5/02; B60J 10/00; B60J 10/86

(52) U.S. Cl. CPC G01L 1/04; B23P 19/047; B60J 10/86; G01B 5/02; B60J 10/45; G01B 3/12

(57) ABSTRACT

The present disclosure provides a method and device for applying a flexible seal to a periphery of a component, in particular a door of a motor vehicle. The seal is transported to an application site on the component at a variable speed and connected to the component migrating along the periphery of the component. The length of the seal is measured along the migrating application site and the length of the seal applied to the component is determined via this length measurement. The device includes an application head which transports the seal to the application site and connects it to a component at the application site. A measuring device is arranged in the region of the application head, via which the length of the applied seal is determined.

### CROSS-REFERENCE TO RELATED APPLICATIONS

This application claims priority to and the benefit of DE 102016221271.0 filed on Oct. 28, 2016. The disclosure of the above application is incorporated herein by reference.

### FIELD

The present disclosure relates to a method and device for applying a flexible seal to a periphery of a component, in particular a door of a motor vehicle.

### BACKGROUND

The statements in this section merely provide background information related to the present disclosure and may not constitute prior art.

To protect against external influences, e.g. moisture, seals are provided on vehicle doors and on the associated door openings. To fix the seal to the component, the seal and the component each have an adhesive layer. Various devices and methods are known from the prior art which describe transporting the seal to the component and applying the seal to the component.

U.S. Pat. No. 8,649,903 B3 discloses a device with application head which transports the seal to an application site migrating along the periphery of the component. The application head comprises a drive mechanism for setting a variable speed. For this, the drive mechanism has a torque motor which is connected for drive purposes to a drive belt, wherein the drive belt is configured to move a seal through the application head, and with an application wheel which is configured to insert the seal between the application wheel and the periphery of the component. Furthermore, a robot is provided to lift and move either the component or the application head relative to the other element along a predefined travel, and a controller which is configured to control the movement of the robot and set a torque for the torque motor, wherein the torque motor is configured to stop when the predefined torque has been reached and to move the drive belt when the torque lies below the predefined value.

U.S. Pat. No. 5,020,278 A discloses a robot arm for applying seals to a door opening with a presser roller which is attached at one end of the arm and turns with a variable rotation speed. The variable rotation speed allows the robot to follow the path of the periphery more quickly along a straight section than on a corner or curve of the periphery contour.

U.S. Pat. No. 5,067,225 A also discloses a robot arm tool for applying seals to a door or door opening, which comprises a carrier roller for transporting an established length of a seal and a guide roller for delivering the seal and a presser roller for applying the seal to the door opening, wherein the rotation speed of the presser roller can be set variably in order to allow a linear speed on application of the seal.

EP 1,871,627 B1 discloses a method for applying a seal to the periphery of a component by rolling, in that the seal, in particular unwound from a roll, is guided to an application site migrating along the periphery and pressed thereon using an adhesive and secured, wherein the seal is pressed on at the application site independently of the guiding of the seal profile to the application site.

One disadvantage of the prior art described above is that the seal can become detached from the door again. The main cause for detachment of the seal is the separation of the adhesive layer of the seal from the adhesive layer of the component, which is provoked by an excessive pretension of the seal which may result on application of the seal to the component. Previously, it has been known to determine the presence of such stresses only by means of a measuring method in which the seal is destroyed. The destructive test method begins by application of the endless seal to a specimen door. The specimen door is then removed and tensioned on a measurement carrier. The seal is cut through down to the panel at several points using a sharp cutter to form a triangle extending to the foot of the seal. In the next step, the gap width of the foot cut is measured with a ruler and recorded, then the seal is detached from the door over 100 mm on both sides of the cut. Then after a few minutes, any extension/compression becomes visible in that when laid together, the two ends have a gap (extension) or abut each other (compression); this gap is measured and also recorded.

### SUMMARY

The present disclosure provides detecting on-line, i.e. during application of the seal, a stress present in the seal which may lead to separation of the seal from the component.

According to the present disclosure, a method for applying a seal to a periphery of a component with the features of claim 1 is provided and includes a device for applying a seal to the periphery of a component with the features of claims 8 and 14.

It is pointed out that the features and measures specified individually in the following description may be combined with one another in any desired technically meaningful way and disclose further refinements of the present disclosure. The description, in particular in conjunction with the figures, characterizes and specifies the present disclosure further.

In the method according to the present disclosure for applying a flexible seal to the periphery of a component, in particular a door of a motor vehicle, the seal is transported to an application site on the component at a variable speed, and connected to the component at the application site migrating along the periphery of the component, wherein the length of the seal is measured along the migrating application site, wherein the length of the seal applied to the component is determined via the length measurement.

The length of the seal to be applied is fixedly predefined by the periphery of the component. During the process of applying the flexible seal, because of the shape of the component, extension or compression of the applied seal can occur so that the seal is connected to the component with a pre-extension or pre-compression. Due to extension or compression of the seal, the length of the seal actually applied is shorter or longer than the periphery of the component. In the present disclosure, it has been found that by determining the length of the seal actually applied to the component, any stresses in the seal can be detected. Determining the length of the seal during the application process offers the advantage of direct monitoring of the applied seal with regard to any stress created in the applied seal during the application process.

One possibility for establishing whether a stress has been created in the applied seal is to compare the determined length of the seal with a predefined length for the seal. The predefined length may for example be the peripheral length of the component or portions of the peripheral length of the component. Comparison of the determined length with the predefined length shows, in a simple fashion, whether the seal has been stretched or compressed during the application process, and accordingly whether a stress has occurred in the applied seal.

In one form of the method according to the present disclosure, it is provided that when the determined length exceeds a predefined limit value based on the predefined length of the seal, the component is checked by an operator or the component is rejected. According to this form, it is determined whether the stress detected is tolerable. A tolerable stress is a stress which is not sufficient to provoke a separation of the seal from the door. If the stress determined lies within a predefined tolerance range, it is provided that the component be checked by an operator. If the limit value of the tolerance range is exceeded, it is provided that the component may also be rejected.

The periphery of the vehicle door includes not only of straight sections which connect the corners together, but the peripheral contour has various curved sections and also rounded transitions which alternate with straight sections. In order to be able to follow this contour adequately, in one form it is provided that the seal is transported with variable speed. Because of this, the periphery of the component is divided into segments, to which the seal is transported with a respective speed. The number of segments varies from door model to door model and may be defined accordingly. In a further form of the method according to the present disclosure, the seal may be divided into segments, wherein the segments are divided on the basis of the shape of the component (similarly to the speed segments), and the lengths of the individual seal segments are determined.

In another form, it is provided that the seal is applied as a one-piece sealing strip. The varying transport speed for the individual segments can be set by a suitable transport device e.g. an application head. The transport device, i.e. the application head, may comprise a control unit which is also connected to the measurement roller, so that verifiable measurements can be performed. In this form, the sealing strip need not be trimmed to the individual segment portion lengths, but rather applied integrally, avoiding cut edges. The cut edges would then have to be adequately sealed against each other. One cut edge is naturally provided. Alternatively, It is naturally possible to cut the individual sealing segments from a sealing strip and apply them in this way. The seal is fed continuously from an endless application roller on the plant, cut off at the end of the last door segment, and connected to the start of the seal on the first door segment as a butt joint.

The present disclosure furthermore comprises a device which is suitable for performing the method described above.

The device according to the present disclosure for applying a flexible seal to the periphery of a component, in particular a door of a motor vehicle, comprises an application head which transports the seal to an application site migrating along the periphery of the component and connects it to a component at the application site, wherein the seal is transported to the application site at a variable speed. According to the present disclosure, it is provided that the device has a measuring device arranged in the region of the application head, via which the length of the applied seal is determined.

The provision of a length measurement device in the region of the application head, as well as the advantages already discussed above, offers the advantage that the length of the seal actually applied is determined without extensions or compressions which may occur during the application process. Knowledge of this actual length of the seal applied may be used to establish a stress in the seal applied.

In one form of the present disclosure, the measuring device comprises a rotatable measuring roller which is oriented axially transversely to the transport direction of the seal and pressed against the seal with a predefined pressure, so that the measuring roller rotates on transport of the seal. By driving the measurement roller on the basis of transport of the seal, the roller rotates according to the length of the seal actually applied, so that the length of the seal applied can easily be determined by the rotation of the measurement roller.

In the present disclosure, in one form, it was found that using a presser roller, a non-destructive measurement of the length of the applied seal is possible.

To provide for the drive of the measuring roller to remain constant throughout transport of the seal, the measuring roller presses against the seal with a predefined pressure. According to one form, the predefined pressure may be produced via a pneumatic cylinder which presses the measuring roller against the seal with a constant pressure.

Another possibility for providing the drive of the measurement roller by the transport of the seal is for the measuring roller to have, on its periphery, means for creating a form-fit connection with the seal. The provision of a knurling offers the advantage that the splines of the knurling connect to the seal by interference fit, so that the length can be measured without slippage or destruction.

According to one form, it is provided that the measuring device comprises an analysis device which determines the length of the applied seal from the rotation of the measuring roller. Furthermore, the analysis device may also be refined such that it determines a stress in the applied seal from the length determined.

The present disclosure indicates how the stresses and/or extensions of the sealing strip, for example on a door of a motor vehicle, can be determined non-destructively directly on installation. If the actual length of the seal exceeds a predefined limit value, measures are taken for visual inspection by an operator or for direct rejection of the unsatisfactory component.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a depiction of a device for applying a seal to a door in accordance with the principles of the present disclosure;

FIG. 2 shows a detail view of an application head with a measuring device according to the present disclosure;

FIG. 3 shows front view of a measuring device according to the present disclosure;

FIG. 4 shows a front view of a door according to the present disclosure; and

FIG. 5 shows a side view of a measuring device according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

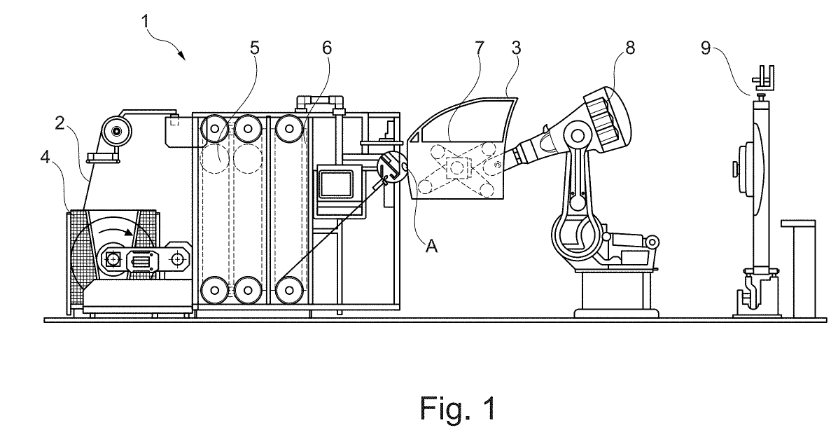

FIG. 1 shows a device 1 for applying a seal 2 to a door 3 of a motor vehicle. The device 1 comprises a load carrier 4 which is a roll with a seal 2 wound thereon. The seal 2 is unwound from the load carrier 4 and guided through a storage unit 5, wherein a profile check 6 is carried out in the storage unit 5.

After the profile check 6, the seal 2 is supplied to an application head 7, wherein the application head 7 transports the seal 2 to the application site A at variable speed and there connects it to the door 3. The speed is dependent on the configuration of the respective application site A.

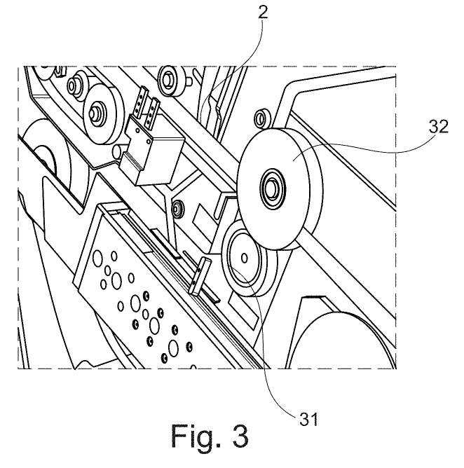

The application site A is the point on the periphery of the door 3 at which the seal 2 is attached. The door 3 is removed from a door hanger 9 via a robot arm 8 and transported to the region of the application site A. After reaching the application site A, the robot turns the door along the application head 7, whereby the application site A migrates along the periphery. The periphery of the door 3 includes not only of straight sections which connect the corners together, but the peripheral contour has various curved sections and also rounded transitions which alternate with straight sections. In order to be able to follow this contour adequately, in another form it is provided that the seal 2 is transported with variable speed. Because of this, the periphery of the component, i.e. the exemplary door 3, is divided into segments to which the seal 2 is transported with a respective speed, as will be explained in more detail with reference to FIG. 3.

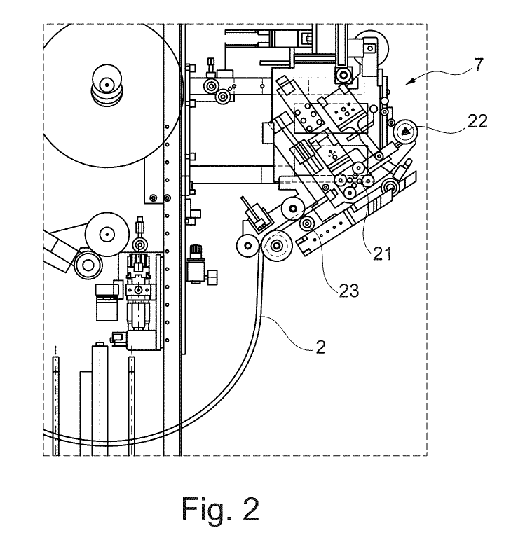

FIG. 2 shows a detailed view of the application head 7. The seal 2 is supplied to the application head 7 at its lower end. A transport device 21 is situated in the application head, and includes two pairs of conveyor rollers which can be driven variably. The conveyor rollers transport the seal to a presser roller 22 which presses the seal 2 to the periphery of the component, i.e. the door 3, at the application site and connects it to the component, i.e. the door 3. Upstream of the transport device 21, a measuring device 23 is arranged which determines the length of the applied seal 2 before the seal 2 is attached to the door 3. A detailed depiction of the measuring device 23 can be seen in FIGS. 3 and 5.

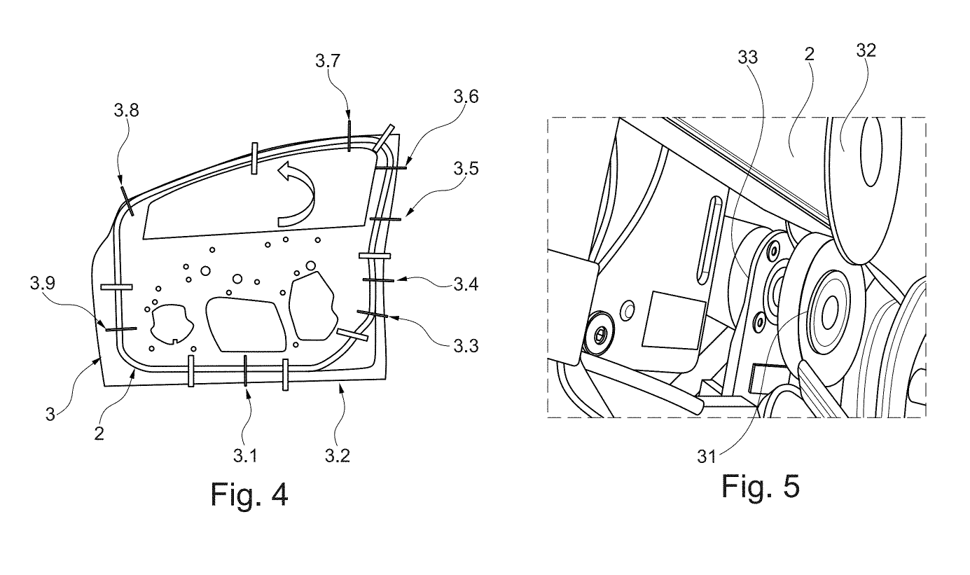

FIG. 4 shows that along its periphery, the door 3 is for example divided into nine segments 3.1 to 3.9 to which the seal 2, i.e. the sealing strip, is transported with different transport speeds to the respective segment 3.1 to 3.9. The division into segments with the specific length and specific boundary points is purely exemplary and should not be restrictive. Naturally, the division may be different in other door configurations. The respective segment 3.1 to 3.9 has a specific length. The sum of the individual lengths gives the desired length of the seal 2. The transport speed of the seal 2 initially has a specific amount which is taken as 100%. In the individual segments 3.1 to 3.9, the transport speed has a higher, equal or a lower amount. The component, i.e. the door 3, is moved according to the rotation direction which is indicated purely as an example. The seal 2 is transported with a speed of 96% in the segment 3.1. In the adjacent segment 3.2, the transport speed of the seal 2 has an amount of 104%. In the adjacent segment 3.3, the transport speed of the seal 2 has an amount of 100%. In the adjacent segment 3.4, the transport speed of the seal 2 has an amount of 95%. In the adjacent segment 3.5, the transport speed of the seal 2 has an amount of 100%. In the adjacent segment 3.6, the transport speed of the seal 2 has an amount of 103%. In the adjacent segment 3.7, the transport speed of the seal 2 has an amount of 97%. In the adjacent segment 3.8, the transport speed of the seal 2 has an amount of 96%. In the adjacent segment 3.9, the transport speed of the seal 2 has an amount of 97%. The acceleration or deceleration of the seal 2 to the respective speed amount in the respective segment may take place in steps at the segment boundaries, i.e. directly. It is also possible for the speed amount to increase or decrease at switch points arranged in the respective segment. However, a step-like speed adaptation at the segment boundaries is possible. The regions encircled in FIG. 3 are particular expansion/compression regions of the applied seal.

FIG. 3 shows a three-dimensional front view of the measuring device 23. The measuring device includes a measuring roller 31 which is arranged axially transversely below the seal 2, so that it lies against the seal 2. The measuring roller 31 is pressed against the seal 2 with a constant pressure by a pneumatic cylinder (not shown). To inhibit the flexible seal 2 from deflecting upwards under the pressure of the measuring roller, a counter-pressure roller 32 is arranged above the seal 2.

FIG. 5 shows a three-dimensional front view of the measuring device 23. This depiction shows that the measuring roller 31 is connected to an encoder 33 which is used to determine the length. Furthermore, a knurling is provided on the periphery of the measuring roller 31 which allows a firm engagement of the measuring roller 31 in the seal 2, and thus provides that the measuring roller 31 rotates according to the transport speed of the seal 2.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for applying a flexible seal to a periphery of a component, in particular a door of a motor vehicle, the method comprising:
transporting the seal to an application site on the component at a variable speed; and
connecting the seal to the component at the application site migrating along the periphery of the component,
wherein a length of the seal is measured along the migrating application site and the length of the seal applied to the component is determined via the length measurement.

2. The method as claimed in claim 1, wherein a determined length of the seal is compared with a predefined length of the seal to detect stresses in the seal.

3. The method as claimed in claim 2, wherein the predefined length of the seal is defined by an entire peripheral length of the component.

4. The method as claimed in claim 2, wherein the predefined length of the seal is defined by portions of a peripheral length of the component.

5. The method as claimed in claim 2, wherein when the determined length of the seal exceeds a predefined limit value based on the predefined length of the seal, the component is checked by an operator or the component is rejected.

6. The method as claimed in claim 1, wherein the seal is divided into segments based on a shape of the component, and a length of the individual seal segments are determined.

7. A device configured to apply a flexible seal according to the method of claim 1, the device comprising:
an application head to transport and connect the seal to the application site; and
a measuring device proximate the application head to measure the length of the applied seal.

8. A device for applying a flexible seal to a periphery of a component, in particular a door of a motor vehicle, the device comprising:
an application head operable to transport the seal and connect the seal to an application site migrating along the periphery of the component, wherein the seal is transported to the application site at a variable speed; and
a measuring device disposed proximate the application head and measures the length of the applied seal.

9. The device as claimed in claim 8, wherein the measuring device comprises a rotatable measuring roller oriented axially transversely to a transport direction of the seal and presses against the seal with a predefined pressure so that the measuring roller rotates when the seal is transported.

10. The device as claimed in claim 9, wherein the measuring device comprises a pneumatic cylinder that presses the rotatable measuring roller against the seal with a constant pressure.

11. The device as claimed in claim 9, wherein a periphery of the rotatable measuring roller creates a form-fit connection with the seal.

12. The device as claimed in one of claims 9, wherein the measuring device comprises an analysis device that determines the length of the applied seal from the rotation of the measuring roller.

13. The device as claimed in claim 12, wherein the analysis device determines at least one of an extension or compression of the applied seal from the determined length.

14. An application head for applying a flexible seal to a periphery of a component, the application head comprising:
a transportion device that transports the flexible seal to an application site migrating along the periphery of the component at a variable transportation speed;
a connection device to connect the flexible seal to the periphery of the component; and
a measuring device disposed upstream of the transportion device and determines the length of the applied flexible seal.

15. The application head as claimed in claim 14, wherein the transport device includes at least one pair of conveyor rollers driven at variable speeds.

16. The application head as claimed in claim 14, wherein the connection device is a press roller.

17. The application head as claimed in claim 14, wherein the flexible seal is a one-piece sealing strip that is continuously fed into the transportation device.

18. The application head as claimed in claim 14, wherein the periphery of the component is divided into segments and each segments determines the transportation speed of the flexible seal to that respective segment.

19. The application head as claimed in claim 18, wherein the measuring device determines the length of applied flexible seal to each segment.

20. The application head as claimed in claim 18, wherein a change in transportation speed of the flexible seal occurs at segment boundaries or at points between segment boundaries.
